(19) United States
(12) Patent Application Publication
(10) Pub. No.: US 2024/0342763 A1
(43) Pub. Date: Oct. 17, 2024

(54) SYSTEMS AND METHODS FOR AN IONIZING BAR FOR AIR NOZZLE MANIFOLDS

(71) Applicant: Illinois Tool Works Inc., Glenview, IL (US)

(72) Inventor: Timothy Douglas Hessel, Cincinnati, OH (US)

(21) Appl. No.: 18/635,704

(22) Filed: Apr. 15, 2024

Related U.S. Application Data
(60) Provisional application No. 63/496,662, filed on Apr. 17, 2023.

(51) Int. Cl. B08B 5/02

(52) U.S. Cl. CPC B08B 5/02

(57) ABSTRACT

Systems and methods are provided that include an air blower and an air manifold with a main body having an inlet coupled to the air blower and a plurality of outlet openings. Each of the outlet openings is coupled to a nozzle. An ionizer bar includes a housing, a power cable contained within the housing, and a plurality of emitter pins electrically coupled to the power cable. A low voltage power supply provides low voltage power to energize the ionizer bar. A cartridge includes two side plates forming a channel in which the ionizer bar is mounted. The cartridge is removably couplable to an interior of the main body of the air manifold.

### CROSS REFERENCE TO RELATED APPLICATIONS

This application is a Non-Provisional Patent Application claiming priority to U.S. Provisional Patent Application No. 63/496,662 entitled “Systems And Methods For An Ionizing Bar For Air Nozzle Manifolds” filed Apr. 17, 2023, which is herein incorporated by reference in its entirety.

### BACKGROUND

Examples of the present disclosure relate generally to air cleaning and static neutralizing systems, and more particularly, to an ionizing bar mounted into an air nozzle manifold.

Conventional bottle or can-filling applications often utilize compressed air to clean the bottles or cans on the assembly line prior to filling. Similarly, it is often desirable to neutralize static electricity which builds up or is otherwise introduced in the bottles or cans during a filling operation. Discrete nozzles were therefore used to blow ionized compressed air into the bottles or cans to accomplish both tasks at once. However, these solutions are costly due to the use of compressed air and the cost for powering the electrical components of the discrete nozzles. Maintenance is also difficult to perform on the discrete nozzles.

Alternatives to compressed air nozzles, such as air manifolds having a series of nozzles, air knives, or the like, may be used to direct air received at an inlet from a blower. It is desirable to provide a cleaning and static neutralizing system that utilizes blown, rather than compressed, air, and which allows for the use of an efficient static neutralizing device that is simple to manage and service as part of the blown air system without compromising the desired effects of the blown air.

Limitations and disadvantages of conventional and traditional approaches will become apparent to one of skill in the art, through comparison of such systems with the present disclosure as set forth in the remainder of the present application with reference to the drawings.

### BRIEF SUMMARY

Systems and methods for treating an object are disclosed herein. An example of the present disclosure comprises a processing system including an air blower and an air manifold including a main body having an inlet coupled to the air blower and a plurality of outlet openings. Each of the outlet openings is coupled to a nozzle. An ionizer bar includes a housing, a power cable contained within the housing, and a plurality of emitter pins electrically coupled to the power cable. A cartridge includes two side plates forming a channel in which the ionizer bar is mounted. The cartridge is removably couplable to an interior of the main body of the air manifold. In some examples, the ionizer bar is powered by a low voltage input.

Certain aspects of embodiments disclosed herein by way of example are summarized below. It should be understood that these aspects are presented merely to provide the reader with a brief summary of certain forms an invention disclosed and/or claimed herein might take, and that these aspects are not intended to limit the scope of any invention disclosed and/or claimed herein. Indeed, any invention disclosed and/or claimed herein may encompass a variety of aspects that may not be set forth below.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of a processing system in accordance with an example of the present disclosure;

FIG. 2 is a perspective view of an air manifold in accordance with the example of the present disclosure;

FIGS. 3A and 3B are detailed perspective views of the air manifold of FIG. 2 with the ionizer bar installed;

FIGS. 4A and 4B are perspective and side views of a bracket for securing the ionizer bar to the air manifold in FIG. 3;

FIG. 5A is a top plan view of a cartridge for securing the ionizer bar to the air manifold in FIG. 3;

FIG. 5B is a bottom side perspective view of the cartridge of FIG. 5A;

FIG. 6 is a right side elevational view of the ionizer bar of FIG. 3;

FIG. 7 is a front side elevational view of the ionizer bar of FIG. 3;

FIG. 8 is a front side perspective view of an air knife in accordance with another example of the present disclosure;

FIG. 9 is a front side perspective view of an air manifold in accordance with yet another example of the present disclosure;

FIG. 10 a cross-sectional front side elevational view of the air manifold of FIG. 9 with the ionizer bar installed; and

FIG. 11 side view of a nozzle and elongated cylindrical shaft coupled thereto for use in the air manifold of FIG. 9.

The figures are not necessarily to scale. Where appropriate, the same or similar reference numerals are used in the figures to refer to similar or identical elements.

### DETAILED DESCRIPTION

One or more specific embodiments will be described below. These described embodiments are provided only by way of example, and do not limit the scope of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An advantage of the disclosed system allows for mounting ionizing bars inside a housing and/or manifold (e.g., for a system employing air knives). The disclosed systems are configured to be powered by a low voltage power supply. The disclosed ionizing bar and/or the low voltage power supply may be mounted inside of an air knives system (e.g., within the manifold, adjacent to the manifold, etc.).

In disclosed examples, a processing system for air nozzle manifolds includes an air manifold comprising a main body having an inlet coupled to an air blower and a plurality of outlet openings; and an ionizer bar arranged within the main body, wherein the ionizer bar is connected to a low voltage power supply to provide low voltage power to the ionizer bar.

In some examples, the ionizer bar is connected to the low voltage power supply via one or more power cables, the one or more power cables connecting to the air manifold or the ionizer bar via one or more fittings. In examples, the system further includes an insulating housing supporting the ionizer bar within the main body. In examples, one or more emitter pins are electrically coupled to the power cable, and to the ionizer bar through the insulating housing.

In examples, the system further includes one or more brackets to mount the ionizer bar within the air manifold, the ionizer bar secured to the one or more brackets via one or more removable fasteners. In examples, the one or more brackets are fixed to an interior of the main body of the air manifold.

In some examples, each of the outlet openings is coupled to a nozzle to blow ionized compressed air towards an object or environment.

In examples, the system further includes a second ionizer bar coupled to the low voltage power supply. In examples, the second ionizer bar is arranged within the air manifold housing.

In examples, the system further includes one or more cartridges including two side plates forming a channel in which the ionizer bar is mounted, the one or more cartridges being removably couplable to an interior of the main body of the air manifold.

In some disclosed examples, a processing system includes a low voltage power supply; an air blower; an air manifold comprising a main body having an inlet coupled to the air blower and a plurality of outlet openings, each of the outlet openings being coupled to a nozzle; an ionizer bar supported by a housing, a power cable connected to the low voltage power supply to provide low voltage power to the ionizer bar; and one or more brackets to mount the ionizer bar within the air manifold, the ionizer bar secured to the one or more brackets via one or more removable fasteners.

In some examples, the low voltage power supply is located within the air manifold.

In some examples, the low voltage power supply is located adjacent to the air manifold.

In some examples, the power cable is contained within a portion of the housing, and a plurality of emitter pins electrically couple the ionizer bar to the power cable.

In some examples, the housing is an insulating housing surrounding a portion of the ionizer bar.

In some examples, the low voltage power supply delivers 24 volts direct current (DC) power.

In some examples, the low voltage power supply is connected to a remote power source.

In examples, the system further includes a remote control panel/station to provide user control of the processing system, including controlling an ionization level of the ionizer bar or monitoring feedback of one or more outputs or conditions related to an ionization process.

In examples, the system further includes a second air manifold housing a second ionizer bar. In examples, the remote control panel/station is configured to provide operational control the ionizer bar and the second ionizer bar.

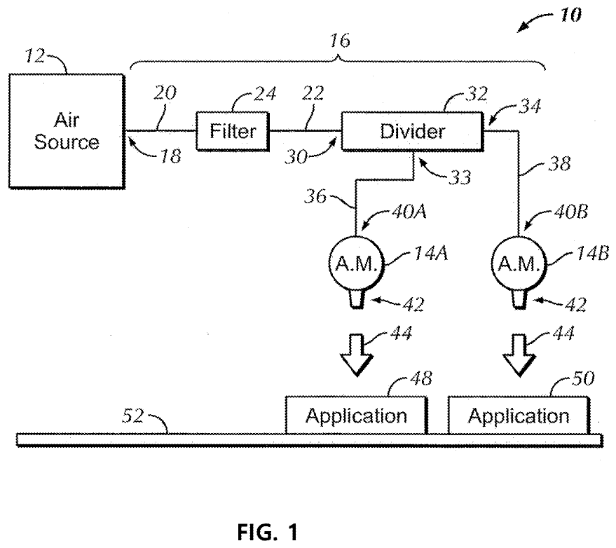

Referring to the drawings, wherein the same reference numerals are used to designate the same components throughout the several figures, there is shown in FIG. 1 a processing system 10 that includes an air supply source 12 configured to deliver a fluid (e.g., air) to air manifolds 14A and 14B along a flow path 16. In the illustrated example, the flow path 16 includes fluid conduits 20, 22, 36, and 38, a filter 24, and a divider 32.

The air supply source 12 may include a high flow centrifugal blower (“air blower”) which, in some examples, may include a supercharger and motor configuration. In one example, the operating characteristics of the air blower 12 may provide an air flow having a pressure of between approximately 1-10 pounds per square inch (psi) and having a flow rate of between approximately 50-2000 cubic feet per minute (CFM) or more specifically, between approximately 150 to 1500 CFM. In some examples, the air blower 12 may be housed within an enclosure. The air blower 12 may be separated from the air manifolds 14A and 14B by a distance of 10, 20, 30, 40, 50, 100, or 200 feet or more. As such, the flow path 16 is configured to provide a path through which air provided by the air blower 12 may be routed and ultimately delivered to the air manifolds 14A and 14B.

The air blower 12 may include an outlet 18 coupled to the fluid conduit 20 that defines a first portion of the flow path 16. The fluid conduit 20 may be a hose, such as a flexible hose, a pipe, such as a stainless steel pipe or a polyvinyl chloride (PVC) pipe, ductwork, or the like. Adapters (not shown) may be used in the flow path 16 to provide an interface for coupling dissimilar conduit materials, such as a hose and a pipe. A filter 24 may be disposed downstream of the air blower 12. As shown in FIG. 1, the filter 24 is interposed between the conduits 20, 22. Operation of the filter 24 will be described in further detail below.

The flow path 16 continues to the distal end of the conduit 22, which may be coupled to an inlet 30 of a flow divider 32 that receives the air flow. The flow divider 32 may be configured to distribute or split the air flow to multiple outlets 33 and 34. Additional fluid conduits 36 and 38 may respectively couple the outlets 33 and 34 to the air manifolds 14A and 14B, respectively. In the illustrated example, the air manifolds 14A and 14B may each include an inlet (40A and 40B) configured for a hose connection, and the fluid conduits 36 and 38 may thus be provided as hoses, such as flexible hoses or the like. In other examples, a pipe may be disposed between the divider 32 and one of the air manifolds 14A or 14B, whereby adapters (not shown) are coupled to each end of the pipe to facilitate a fluid connection between hoses extending from an outlet (e.g., 33 or 34) of the divider 32 and from an inlet (e.g., 40A or 40B) of one of the air manifolds (e.g., 14A or 14B). In some examples, the system 10 may include only a single air manifold (e.g., 14A) and thus may not include a divider 32. In such examples, the fluid conduit 22 may be coupled directly to the air manifold 14A.

As shown in FIG. 1, the air flow 44 exiting the air manifolds 14A and 14B may be directed towards applications 48 and 50, respectively, of the processing system 10. For example, the applications 48, 50 may be transported through the system 10 along a conveyor belt 52 or other suitable type of transport mechanism. As will be appreciated, the system 10 may utilize the air flow 44 provided by the air manifolds 14A and 14B, respectively, for a variety of functions, including but not limited to drying products, removing dust or debris, coating control, cooling, leak detection, surface impregnation, corrosion prevention, and the like. For example, in certain examples, the system 10 may be used for drying food or beverage containers, such as cans or bottles, or may be a system for removing dust and other debris from sensitive electronic products, such as printed circuit boards (PCBs) or the like. In addition, some examples of the system 10 may also utilize the air flow 44 to clean and/or remove debris from the conveyer belt 52.

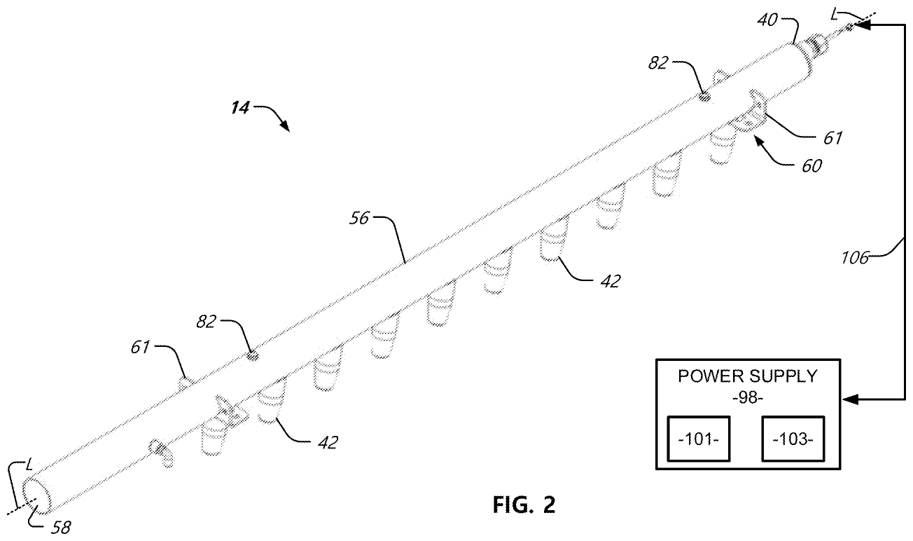

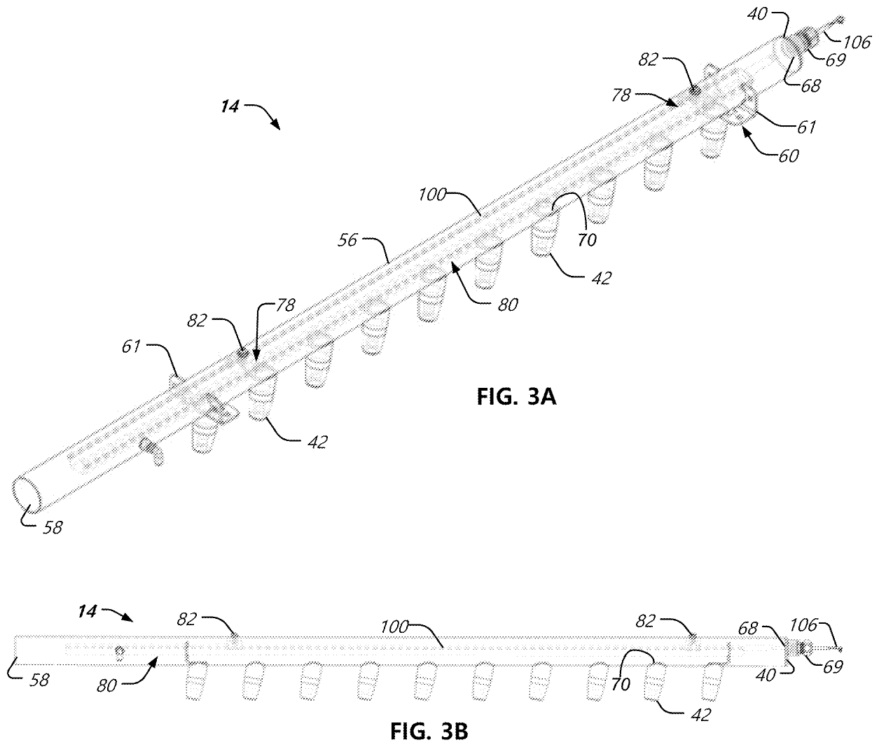

FIGS. 2 and 3 show the example air manifold 14 for use in the system 10 of FIG. 1. The air manifold 14 includes a main body or housing 56 which includes an axial length (e.g., measured along the longitudinal axis L) between approximately 0.5 feet to 4 feet (e.g., 0.5, 1, 1.5, 2, 2.5, 3, 3.5, or 4 feet, or less or more) or greater, although other axial lengths of the main body 56 may be used as well. For example, in some examples, the length may also be greater than 4 feet (e.g., 5, 6, 7, 8 feet, or less or more, or the like).

The main body 56 in the depicted example is generally cylindrical in shape (e.g., having a generally circular cross section). In other examples, the main body 56 may have an oval-shaped cross-section, a diamond-shaped cross-section, a triangular-shaped cross-section, a square or rectangular-shaped cross-section, or the like. A first end of the main body 56 is open and forms the inlet 40. As described above, air supplied by the air source 12 may be routed to the air manifold 14 through the inlet 40 and discharged via a plurality of nozzles 42. For example, the inlet 40 may be coupled to a fluid conduit (e.g., conduit 36). A second end (a sealed end) of the main body 56 that is opposite the inlet 40 may be sealed by an end cap 58. In certain examples, the end cap 58 may have a shape that is generally the same as the cross-sectional shape of the main body 56 (e.g., circular). The end cap 58 may be joined to the main body 56 by welding (e.g., tungsten inert gas (TIG) welding), fastened to the main body 56 using one or more screws, bolts, or any other suitable type of fastener, adhesive, or the like.

In some examples, the main body 56 of the air manifold 14 may include one or more mounting brackets 60 for mounting of the air manifold 14 to an assembly line. The mounting brackets 60 may be welded to the main body 56, although other methods of connection, such as adhesive, mechanical fasteners, or the like may be used to secure the brackets 60 to the main body 56. In the example shown, the mounting brackets 60 are each formed by a plate 61 extending radially outwardly from the main body 56, and each includes a plurality of through-holes 62 for receiving mounting screws (not shown) or like mechanical fasteners for securing the plate 61 to a support (not shown). Other types of mounting brackets 60, including those allowing movement of the main body 56 with respect to the support, including rotational movement, sliding movement, or the like, may also be used.

The inlet 40 and the main body 56 are depicted in FIGS. 2 and 3 as having respective diameters that may be equal. In one example, the diameters of the inlet 40 and the main body 56 are between approximately 1 to 6 inches. In other examples, the diameters of the inlet 40 and the main body 56 may be different sizes. Further, in some examples, the diameter of the main body 56 may vary along the length L thereof. For example, the diameter of the main body 56 may progressively decrease or increase from the inlet 40 end to the sealed end (e.g., having the end cap 58).

The nozzles 42 extend radially outwardly from the main body 56. The main body 56 includes a plurality of openings 70 (FIG. 3), each of which corresponds to a respective one of the nozzles 42. Inlet ends of the nozzles 42 may be welded to the main body 56 via TIG welding or a like attachment process such that air flowing into the main body 56 of the air manifold 14 via the inlet 40 may flow through the openings 70 of the main body 56 and into the respective nozzles 42. That is, each nozzle 42 and its respective opening 70 on the main body 56 defines a flow path by which air within the main body 56 may be discharged from the air manifold 14.

While the depicted example of FIGS. 2 and 3 includes ten nozzles (42), it should be appreciated that various examples may provide any suitable number of nozzles. For example, certain examples may include 2 to 20 nozzles or more. The nozzles 42 may be axially spaced apart along the length L of the main body 56, such that each nozzle 42 is separated in the axial direction. The distances between adjacent nozzles 42 may be identical or may vary, as shown in FIG. 2, and are each between about 1 to 12 inches, although other distances are considered within the scope of this disclosure. Further, the length of a nozzle extending from an external surface of the air manifold main body 56 may be adjusted to accommodate specific environments and/or applications (e.g., enclosure size, object dimensions, processing speed, etc.).

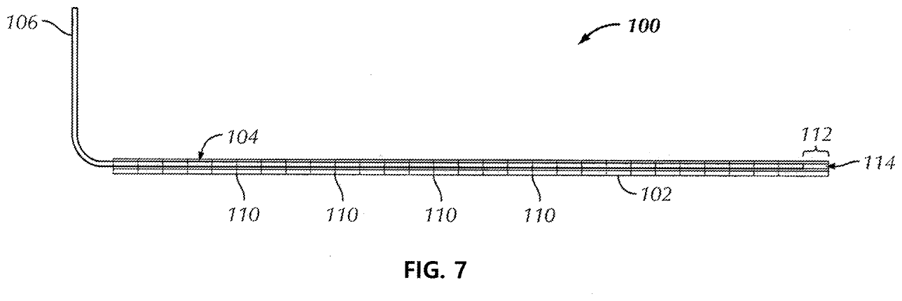

Referring to FIGS. 3, 6, and 7, an ionizer bar 100 is provided for insertion into the main body 56 to generate ions that enter the air flow 44 directed toward the applications 48, 50. The ionizer bar 100 includes a housing 102 made from an insulative material, polytetrafluoroethylene (PTFE), reinforced plastic, or the like. The housing 102 contains at least one hollow channel 104 extending along a length of the ionizer bar 100. The hollow channel 104 is sized and shaped to receive a power cable 106, which may be an insulated cable with a conductive core.

In some examples, a power supply 98 connects to the ionizer bar 100 via the power cable 106. The power supply 98 may be a low voltage power source supplying a voltage over a range of values. For example, the low voltage supplied to the ionizing bar 100 could be lower than 50 V DC (e.g., between 12 V DC and 48 V DC), and may at or about a 24 V DC supply voltage. Although illustrated as being remote from the air manifold 14 and connected to the ionizer bar 100 via the power cable 106, in some examples a low voltage power supply may be arranged adjacent to and/or incorporated within the housing 56. In such an arrangement, the power supply may be connected to a power source (e.g., mains power, generator, energy storage system, etc.) to provide a direct current (DC) or alternating current (AC) input, which may be located remote from the air manifold 14. In an example, the system 10 and power supply 98 provide a 24 V DC supply voltage. Thus, wiring to the ionizer bar 100 can be configured to receive an input from a 24 V DC power supply and/or power converter. Advantageously, the power transmitted to the system 10 and/or ionizer bar 100 can be conveyed by cabling suitable for low voltage power, allowing for wiring options that may be better suited for particular applications and/or environments (e.g., rather than cabling to convey high voltage power).

The power supply 98 may include and/or employ a voltage converter. For example, the voltage converter may include circuitry, switches, transformers, etc., which changes input voltage into a desired output voltage, e.g., the converter transforms the input voltage accordingly. This can include conversion from DC or AC sources, and from high to low, or low to high voltage conversion. Moreover, the power supply to convert and/or regulate the voltage for output to the ionizer bar 100 can be installed inside the ionizer bar itself (and/or within the manifold 14, within a junction at or adjacent to the manifold 14, etc.), avoiding remote and/or separate high voltage power supplies. This allows the power supply 98 and/or the ionizer bar 100 to be protected from the work environment (e.g., impacts, chemicals, fluids, etc.) by mounting them inside the manifold, thereby reducing the overall installation footprint of the air manifold 14 and/or the larger system 10.

Although some examples are directed to a low voltage power source, in some examples the power supply 98 can include circuitry configured to provide a range of voltages greater than 1 kV (e.g., a higher voltage output).

The housing 102 of the ionizer bar 100 also includes, in a bottom surface thereof, a pin slot 108 that extends along and accesses the hollow channel 104. A plurality of pins 110 are electrically coupled to the power cable 106 and extend into the pin slot 108. The pins 110 may be directly connected, resistively connected, or capacitively connected to the low voltage power supply 98 via the power cable 106. Although some examples are directed to a low voltage power supply, in some examples a high voltage power supply is also considered. In the example shown in the drawings, the pins 110 penetrate the insulation of the power cable 106 to establish a physical and electrical connection to the conductive core. However, in other examples, the pins 110 may be coupled to the power cable 106 via terminals, conductive traces, or the like. The pins 110 may be spaced apart in a regular pattern along the length of the housing 102 of the ionizer bar 100 in order to provide an even distribution of ions. For example, the pins 110 may be placed an inch apart from each other along the power cable 106. The pins 110 may be formed from a metal or semiconductor material, such as copper, aluminum, tungsten, titanium, stainless steel, silicon, silicon carbide, or the like.

The ionizer bar 100 may be mounted in the main body 56 of the air manifold 14 with the free end of the power cable 106 located proximate the end cap 58. To prevent a short circuit by inadvertent contact of the power cable 106 or one of the pins 110 with the main body 56, an end portion 112 of the housing 102 of the ionizer bar 100 may be filled with an inert or non-conductive material 114, which may be a polyolefin-based hot melt adhesive. Alternatively, the inert or non-conductive material 114 may be an epoxy, polyurethane, silicon-based compound, or the like.

In some examples, the power supply 98 may include and/or be operatively connected to a controller 99. The controller 99 may include control circuitry 101 to process data, and/or a user interface 103 to allow for a user to provide instructions, make selections, adjust operational parameters, and/or receive feedback, as a list of non-limiting examples. The controller 99 may be located adjacent to the power supply 98 and/or the ionizer bar 100 (e.g., within the processing environment), and/or in a separate location (e.g., outside the processing environment). The controller 99 can be communicably coupled to the power supply 98 and/or the ionizer bar 100 via wired or wireless connections. The user interface 103 may include knobs, dials, buttons, touch-enabled surfaces, and voice and/or motion sensors through which to receive and/or present information, as a list of non-limiting examples.

Although a single ionizer bar 100 is illustrated in several examples, in some examples, two or more ionizer bars may be employed. The multiple ionizer bars may be collocated (e.g., within a single air manifold), and/or may be housed in separate air manifolds and connected via conduits and/or power cables. The multiple ionizer bars may be connected in parallel or in series, and may be controlled together and/or separately (e.g., via controller 99 or other suitable controller).

In some examples, a process may require increased ionization, and therefore employs multiple ionizer bars. For instance, ionization treatment for a material being processed at high-speeds may employ collocated ionizer bars, and/or multiple ionizer bars arranged in or near the process environment.

In some examples, the low voltage ionizer bar disclosed herein can be retrofit into existing systems. Thus, the brackets and housing arrangements, as well as the delivery of low voltage power, can replace components in an existing processing system. For instance, high voltage ionizer bars may be removed and replaced with low voltage ionizer bars, which are mounted and powered as disclosed herein.

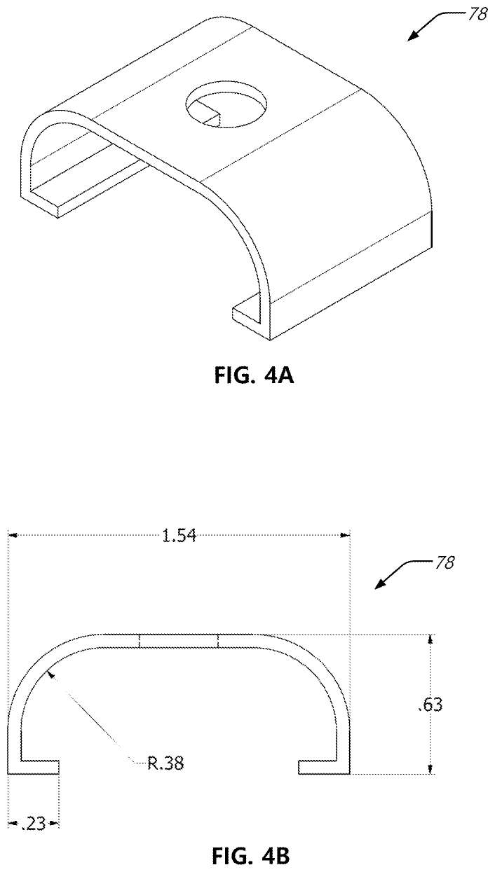

Referring to FIGS. 4A-4B, in some examples the ionizer bar 100 may be mounted within the main body 56 of the air manifold 14 by a bracket 78. The bracket 78 may be permanently connected to the main body 56, such as by welding or the like, but it may be that the bracket 78 is releasably attached to the main body 56 instead to facilitate easier access to the ionizer bar 100 for service and/or replacement. Accordingly, the bracket 78 may be attached to the main body 56 by way of bolts 82 or other mechanical fasteners that extend from the exterior of the main body 56 and into the bracket 78. However, other methods of releasable attachment of the bracket 78, such as latches, hook-and-loop fasteners, or the like may also be used. In some examples, the bracket 78 is attached firmly to the main body 56 to avoid movement of the bracket 78 and ionizer bar 100 as a result of the force of the air flowing through the main body 56.

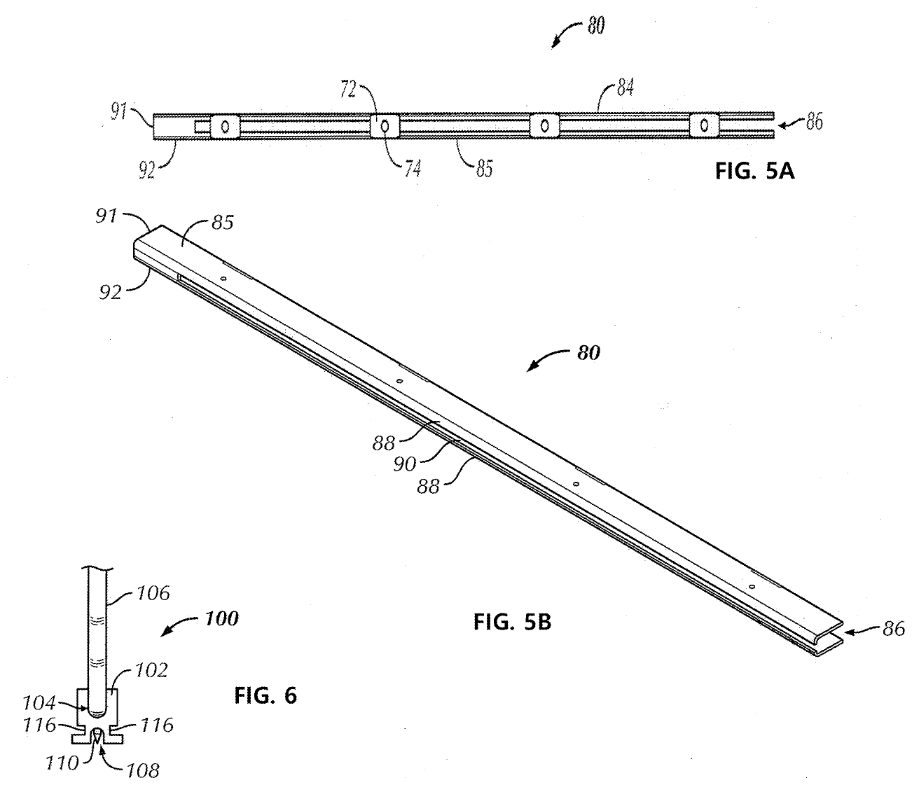

Referring to FIGS. 5A-5B, in some examples the ionizer bar 100 may be mounted within the main body 56 of the air manifold 14 by a cartridge 80. The example cartridge 80 may be used in an application using varying voltage, such as greater than 1 kV. The cartridge 80 may be in the shape of a hollow bar having two side plates 84, 85 arranged to extend parallel to one another and along a length L of the main body 56 of the air manifold 14 when installed. The side plates 84, 85 are spaced apart from one another to form a channel 86 therebetween, which may be sized and shaped to retain the ionizer bar 100. A bottom surface of each of the plates 84, 85 and may include a lip 88 extending perpendicularly to the plates 84, 85 and toward the channel 86. The lips 88 are utilized to support the ionizer bar 100. For example, the lips 88 may abut a bottom surface of the housing 102 of the ionizer bar 100 and allow the pins 110 to extend through a slot 90 formed by the lips 88. However, in some examples, the lips 88 engage respective grooves 116 extending along the housing 102 of the ionizer bar 100 (FIG. 6). In this way the corona discharge of the pins 110 will not be impeded by the cartridge 80. This arrangement allows for convenient insertion and removal of the ionizer bar 100 in the cartridge 80 by way of sliding the ionizer bar 100 into the channel 86. However, other methods of insertion and removal for the cartridge 80, such as clips or other mechanical fasteners, may be used as well.

In some examples, the slot 90 does not extend the entire length of the cartridge 80, but rather stops short of an edge of the cartridge 80 adjacent the inlet 40 of the air manifold 14 in the installed position. The lips 88 may converge at this location of the cartridge 80 to form part of a spacer 92. A top portion of each plate 84, 85 may also converge at this location to form another part of the spacer 92. The spacer 92 may also include an end cap 91. The spacer 92 seals off the end of the cartridge 80 proximate the inlet 40 of the air manifold 14 to prevent air from accessing the power cord 106 of the ionizer bar 100.

Specifically, the power cord 106 may be gripped by a fitting 69 and inserted into the air manifold 14 through a cord opening 68 at a top of the main body 56 proximate the inlet 40. The channel 86 of the cartridge 80 is aligned with the cord opening 68 such that when the fitting 69 is secured in the cord opening 68, the power cord 106 is immediately received in the channel 86 of the cartridge 80 and is not exposed to pressurized air entering the main body 56 through the inlet 40. However, the fitting 69 and cord opening 68 may be positioned at other locations of the air manifold 14.

A plurality of nut plates 72 may be provided on the top portion of the cartridge 80, each of which is welded or otherwise mechanically fastened to the plates 84, 85. Each nut plate 72 may include a threaded hole 74 extending at least partially therethrough. The threaded holes 74 may be spaced on the cartridge 80 to align with corresponding bolt holes formed in a top of the main body 56. The bolts 82 are placed through the bolt holes and are threaded into the threaded holes 74 of the nut plates 72 to secure the cartridge 80 to the main body 56 of the air manifold 14.

Referring again to FIG. 1, the filter 24 prevents debris in the airstream from entering and contaminating the applications 48, 50. The filter 24 also prevents debris build-up on the pins 110 of the ionizer bar 100, thereby maximizing the ionization efficiency of the pins 110 for an extended period of time. The filter 24 also prevents contamination and/or damage in the event of upstream failures. For example, air blowers 12 will often have aluminum impellers, which in a catastrophic failure resulting in aluminum on aluminum contact can produce shavings that may enter the airstream, but will be caught by the filter 24.

The filter 24 may have a housing made from stainless steel or a like corrosion-resistant material. Further, the filter 24 may include media (not shown) meeting the High-efficiency particulate air (HEPA) standard (i.e., 99.97% of particles greater than 0.3 micrometers are removed). However, it has been found that a media with 99.99% efficiency at 0.5 micrometers (nominal) allows for better air flow (e.g., with only 10% of the pressure drop experienced when using HEPA filters), and is more than adequate for food and beverage container applications 48, 50. The filter 24 may further include a gauge (not shown) which notifies the user when replacement is necessary.

While only one filter 24 is shown in FIG. 1 placed between the air blower 12 and the divider 32, one or more additional filters 24 may alternatively or additionally be placed between the divider 32 and the air manifolds 40A, 40B. This configuration would be useful in, for example, systems 10 having very high pressure air flow. A filter 24 may also be placed at an inlet (not shown) of the air blower 12.

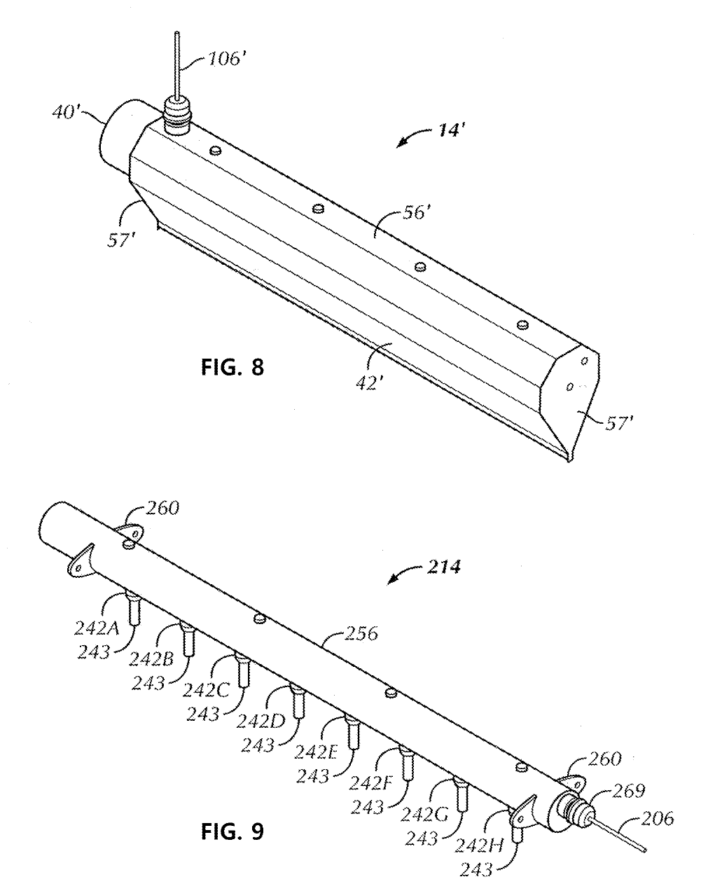

In an alternate example of the disclosure, the air manifold 14 may be replaced by an air knife 14′, as shown in FIG. 8. The air knife 14′ is constructed similarly to the air manifold 14, including the use of an inlet 40′ that receives blown air from the air supply 12, but in place of the nozzles 42 of the air manifold 14, the air knife 14′ includes a discharge slot 42′ that extends along a substantial portion of the length of the main body 56′ thereof. The main body 56′ includes tapered portions 57′ to force the air through the discharge slot 42′. An ionizer bar 100 may be mounted within the air knife 14′ using a cartridge 80 in a similar to fashion as described above.

FIGS. 9-11 show another example of the disclosure specifically designed for use in cleaning bottles (not shown), which typically have small openings. The air manifold of FIGS. 9-11 is similar to the example shown in FIGS. 1-7, and like numerals have been used for like elements, except the 200 series numerals have been used for the example shown in FIGS. 9-11. Accordingly, a complete description of the example of FIGS. 9-11 has been omitted, with only the differences being described.

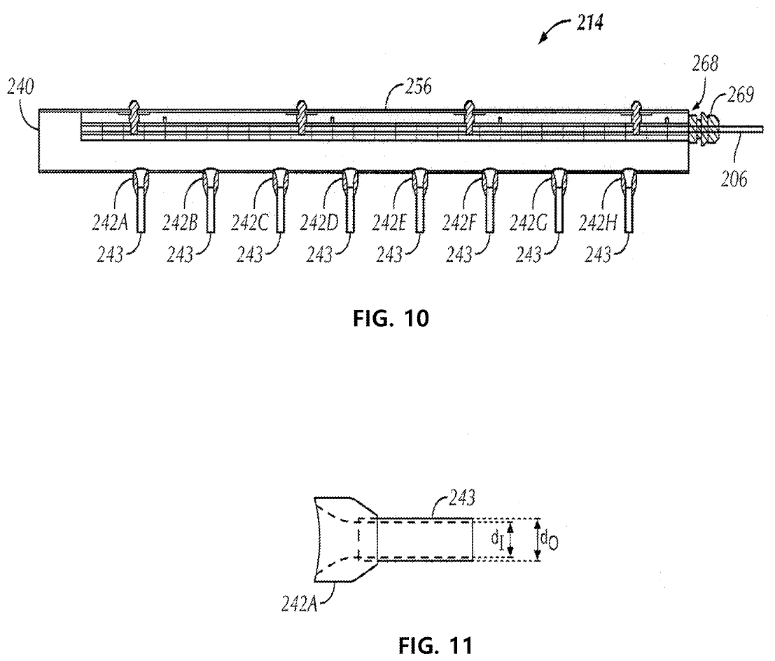

As can be seen in FIGS. 10 and 11, an elongated cylindrical shaft 243 having a constant inner diameter dI may be connected to an outlet of each of the nozzles 242A-242H. The elongated cylindrical shaft 243 does not further compress the air flow through the respective nozzle 242A-242H, but rather maintains the pressure of the air flow 44 at a relative constant. The elongated cylindrical shaft 243 is used to guide the air flow 44 to the small opening of a bottle, for example. The outer diameter do of the elongated cylindrical shaft 243 may be constant along a length thereof. In some examples, the inner diameter dI of the bottle cleaning application may be maximized for air delivery into the bottle while the outer diameter dO is minimized so that air leaving the bottle opening can escape past the elongated cylindrical shaft 243. In an example, the inner diameter dI is about 5/16 of an inch while the outer diameter dO is about ⅜ of an inch, although a variety of diameters are within the scope of this disclosure.

The elongated cylindrical shaft 243 may be friction fit and/or welded to the corresponding air nozzle 242A-242H. However, other methods of attachment, such as adhesive, mechanical fasteners, or the like may be used as well. The elongated cylindrical shaft 243 may also be removable for replacement and/or use of the nozzles 242A-242H without the shafts 243.

FIGS. 9 and 10 also show an alternative arrangement for attaching the power cable 206 to the air manifold 214. Rather than being located at a top or radial surface of the main body 256, the cord opening 268 is provided at the sealed end of the main body 256 opposite to the inlet 240. FIG. 9 also shows a slightly different arrangement of the brackets 260. As previously described, these changes may be made to accommodate the mounting requirements of the air manifold 14, 214 and are not limited by the disclosure.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

As used herein, the terms “first” and “second” may be used to enumerate different components or elements of the same type, and do not necessarily imply any particular order.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to any analog and/or digital components, power and/or control elements, such as a microprocessor, digital signal processor (DSP), software, and the like, discrete and/or integrated components, or portions and/or combinations thereof, including physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

The terms “control circuit,” “control circuitry,” and/or “controller,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

While only certain features of the invention have been illustrated and described herein, many modifications and changes will occur to those skilled in the art. It is, therefore, to be understood that the appended claims are intended to cover all such modifications and changes as fall within the true spirit of the invention.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

What is claimed is:

1. A processing system for air nozzle manifolds comprising:
an air manifold comprising a main body having an inlet coupled to an air blower and a plurality of outlet openings; and
an ionizer bar arranged within the main body, wherein the ionizer bar is connected to a low voltage power supply to provide low voltage power to the ionizer bar.

2. The system of claim 1, wherein the ionizer bar is connected to the low voltage power supply via one or more power cables, the one or more power cables connecting to the air manifold or the ionizer bar via one or more fittings.

3. The system of claim 2, further comprising an insulating housing supporting the ionizer bar within the main body.

4. The system of claim 3, wherein one or more emitter pins are electrically coupled to the power cable, and to the ionizer bar through the insulating housing.

5. The system of claim 1, further comprising one or more brackets to mount the ionizer bar within the air manifold, the ionizer bar secured to the one or more brackets via one or more removable fasteners.

6. The system of claim 5, wherein the one or more brackets are fixed to an interior of the main body of the air manifold.

7. The system of claim 1, wherein each of the outlet openings is coupled to a nozzle to blow ionized compressed air towards an object or environment.

8. The system of claim 1, further comprising a second ionizer bar coupled to the low voltage power supply.

9. The system of claim 8, wherein the second ionizer bar is arranged within the air manifold housing.

10. The system of claim 1, further comprising one or more cartridges including two side plates forming a channel in which the ionizer bar is mounted, the one or more cartridges being removably couplable to an interior of the main body of the air manifold.

11. A processing system comprising:
a low voltage power supply;
an air blower;
an air manifold comprising a main body having an inlet coupled to the air blower and a plurality of outlet openings, each of the outlet openings being coupled to a nozzle;
an ionizer bar supported by a housing, a power cable connected to the low voltage power supply to provide low voltage power to the ionizer bar; and
one or more brackets to mount the ionizer bar within the air manifold, the ionizer bar secured to the one or more brackets via one or more removable fasteners.

12. The system of claim 11, wherein the low voltage power supply is located within the air manifold.

13. The system of claim 11, wherein the low voltage power supply is located adjacent to the air manifold.

14. The system of claim 11, wherein the power cable is contained within a portion of the housing, and a plurality of emitter pins electrically couple the ionizer bar to the power cable.

15. The system of claim 11, wherein the housing is an insulating housing surrounding a portion of the ionizer bar.

16. The system of claim 11, wherein the low voltage power supply delivers 24 volts direct current (DC) power.

17. The system of claim 11, wherein the low voltage power supply is connected to a remote power source.

18. The system of claim 11, further comprising a remote control panel/station to provide user control of the processing system, including controlling an ionization level of the ionizer bar or monitoring feedback of one or more outputs or conditions related to an ionization process.

19. The system of claim 11, further comprising a second air manifold housing a second ionizer bar.

20. The system of claim 19, wherein the remote control panel/station is configured to provide operational control the ionizer bar and the second ionizer bar.
